(19) United States
(12) Patent Application Publication
(10) Pub. No.: US 2007/0171175 A1
(43) Pub. Date: Jul. 26, 2007

(54) LIQUID CRYSTAL DISPLAY DEVICES AND METHODS FOR DRIVING THE SAME

(75) Inventors: Min-Feng Chiang, Taipei County (TW); Hsueh-Ying Huang, Taipei County (TW); Yu-Hui Chou, Taichung County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORP., Hsinchu (TW)

(21) Appl. No.: 11/458,746

(22) Filed: Jul. 20, 2006

(30) Foreign Application Priority Data
Jan. 26, 2006 (TW) 95103062

(51) Int. Cl. G09G 3/36

(52) U.S. Cl. 345/100

(57) ABSTRACT

A method for driving a liquid crystal display panel. A turn-on signal is provided to first gate electrodes in sequence by a first direction and provided to second gate electrodes in sequence by a second direction opposite to the first direction during a frame. A data signal is provided to the data electrodes corresponding to the first gate electrodes and the second gate electrodes while providing the turn-on signal to the first gate electrodes and the second gate electrodes corresponding to the data electrode.

This application claims the benefit of Taiwan Patent Application Serial No. 95103062, filed Jan. 26, 2006, the subject matter of which is incorporated herein by reference.

### BACKGROUND OF THE INVENTION

1. Field of the Invention

The invention relates to a liquid crystal display (LCD) panel, and in particular to a method for driving the LCD panel.

2. Description of the Related Art

FIG. 1 is a schematic diagram of a conventional LCD panel and the peripheral driving circuits thereof. As shown in the figure, an LCD panel 10 is formed by interlacing data electrodes (represented by D1, D2, D3, . . . , D2m) and gate electrodes (represented by G1, G2, G3, . . . , G2n), each pair of which controls a display unit. As an example, interlaced data electrode D1 and gate electrode G1 control display unit P11. The equivalent circuit of each display unit comprises thin film transistors (TFTs) for controlling data input and storage capacitor Cst and liquid crystal capacitor Clc. The gates and drains of these TFTs are respectively connected to gate electrodes (G1-G2n) and data electrodes (D1-D2m). Such a connection turns all TFTs on or off the same line by using a turn-on signal of gate electrodes (G1-G2n), thereby controlling the data signals of the data electrodes to be written to the corresponding display unit.

The conventional LCD driving method achieves visual integration by color mixing. Using 60 Hz as an example, when there are three red (R), green (G), blue (B) sub-display units in a display unit, the response time for each sub-display unit is about 16.7 ms. Visible colors emitted by the sub-display units are a mixed result. However, conventional color sequential driving achieves visible effect by color mixing in time domain, which provides R, G, B light in sequence by a backlight module, with the time period, ⅓ of a frame, for each color, about 5.6 ms. For example, the backlight module can provide R light in a first 5.6 ms, G light in the next 5.6 ms, and B light in the next 5.6 ms. Thus, a display frame mixed from the three sub-frames is visible. It takes about 5.6 ms to drive the R, G, B sub-frames by providing turn-on signals through gate electrodes (G1-G2n) in sequence. Deducting pre-charge time for electrodes and start time for light emitting diode (LED) backlight, only 2 ms remains for liquid crystals to respond. In addition, the time difference between the first turned-on gate electrode G1 and the last turned-on gate electrode G2n causes response delay of the corresponding liquid crystals, resulting in brightness difference in different regions of the LCD panel.

U.S. Pat. No. 5,233,338 discloses a method for driving an LCD panel using sequential color driving, wherein the scan direction of the turn-on signal in the R, G, B sub-frame in the (n+1)th frame is opposite that in the nth frame, where the R, G, B sub-frame of each display unit corresponds to the same gate electrodes.

### BRIEF SUMMARY OF INVENTION

Methods for driving a liquid crystal display panel are provided. The liquid crystal display panel comprises a plurality of first gate electrodes, second gate electrodes, data electrodes, and a plurality of display units respectively connecting to the data electrodes and one of the first gate electrodes and the second gate electrodes, such as a field-sequential color liquid crystal display panel. An exemplary embodiment of such a method comprises providing a turn-on signal to the first gate electrodes in sequence in a first direction and providing the turn-on signal to the second gate electrodes in sequence in a second direction opposite to the first direction during a frame, and providing at least one data signal to one of the data electrode corresponding to one of the first gate electrodes and the second gate electrodes while providing the turn-on signal to the first gate electrodes and the second gate electrodes corresponding to the one of the data electrode.

Another exemplary embodiment of a method comprises providing a turn-on signal to the first gate electrodes in sequence in a first direction and providing the turn-on signal to the second gate electrodes in sequence in a second direction opposite to the first direction during display of an nth frame, providing the turn-on signal to the first gate electrodes in sequence in the second direction and providing the turn-on signal to the second gate electrodes in sequence in the first direction during display of an (n+1)th frame, which is another frame next to the nth frame, and providing a data signal to the data electrode corresponding to one of the first gate electrodes and the second gate electrodes while providing the turn-on signal to the first gate electrodes and the second gate electrodes corresponding to the data electrode.

An exemplary embodiment of a liquid crystal display device comprises a liquid crystal display panel comprising a plurality of first gate electrodes, second gate electrodes, first data electrodes, second data electrodes, and a plurality of display units respectively connecting to the first data electrodes and the first gate electrodes, or the second data electrodes and the second gate electrodes, and at least one driver module providing a turn-on signal to the first gate electrodes in sequence in a first direction, providing the turn-on signal to the second gate electrodes in sequence in a second direction opposite to the first direction, and providing a data signal to the first data electrodes corresponding to the first gate electrodes while the turn-on signal is provided to the first gate electrodes, and to the second data electrodes corresponding to the second gate electrodes while the turn-on signal is provided to the second gate electrodes during a frame.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram of a conventional LCD panel and the peripheral driving circuits thereof;

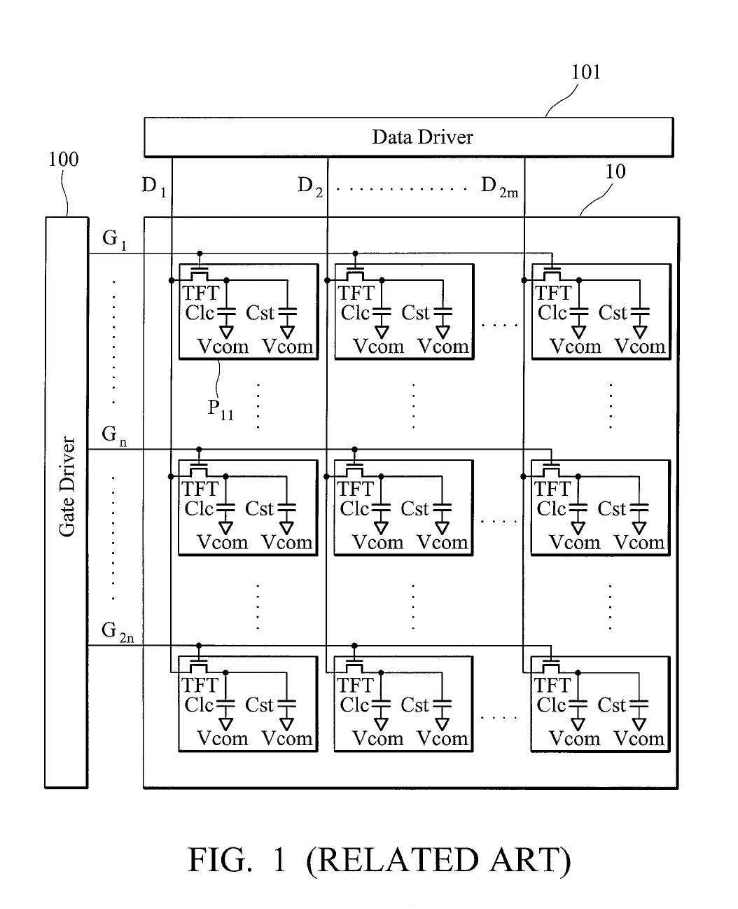

FIG. 2 is a schematic diagram of the LCD panel and the peripheral driving circuits thereof according to an embodiment of the invention;

FIG. 3 is a timing chart of a scanning direction of the LCD panel according to an embodiment of the invention;

FIG. 4 is a timing chart of a scanning direction of the LCD panel according to another embodiment of the invention;

FIG. 5 is a schematic diagram of the LCD panel and the peripheral driving circuits thereof according to another embodiment of the invention;

FIG. 6 is a schematic diagram of the LCD panel and the peripheral driving circuits thereof according to another embodiment of the invention.

FIG. 7 is a schematic diagram of the LCD panel and the peripheral driving circuits thereof according to another embodiment of the invention;

FIG. 8 is a schematic diagram of the LCD panel and the peripheral driving circuits thereof according to another embodiment of the invention;

FIG. 9 is a schematic diagram of the LCD panel and the peripheral driving circuits thereof according to another embodiment of the invention;

FIG. 10 is a schematic diagram of the LCD panel and the peripheral driving circuits thereof according to another embodiment of the invention;

FIG. 11 is a schematic diagram of the LCD panel and the peripheral driving circuits thereof according to another embodiment of the invention; and

FIG. 12 is a schematic diagram of the LCD panel and the peripheral driving circuits thereof according to another embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

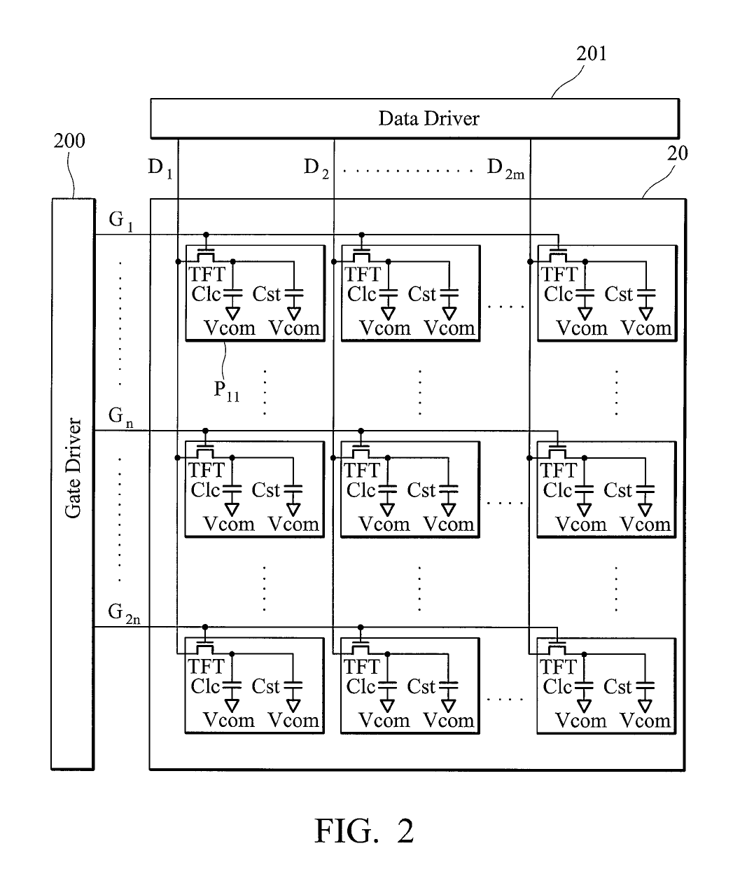

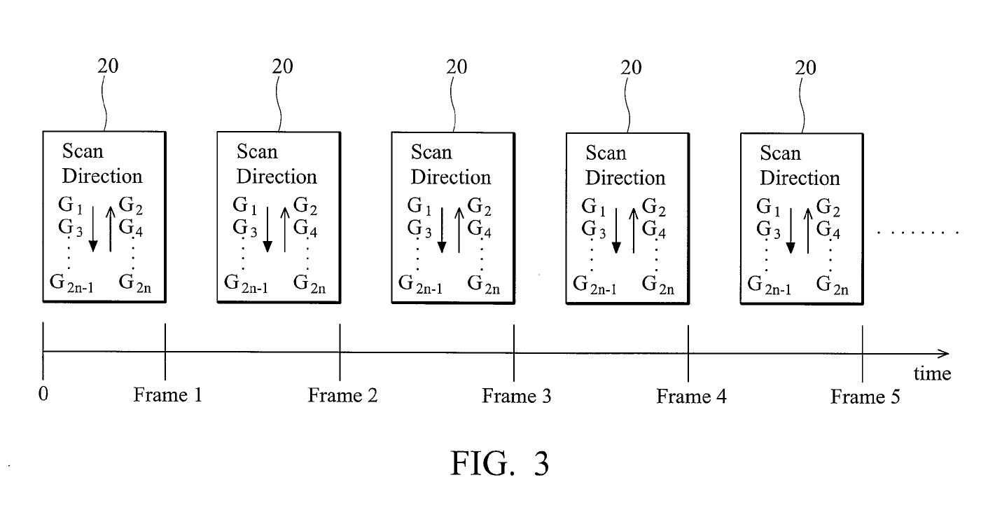

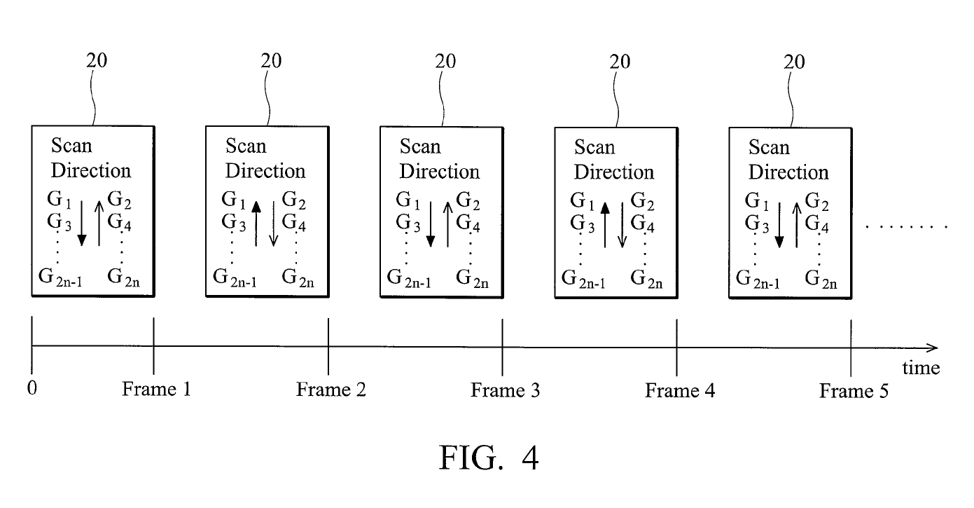

FIG. 2 is a schematic diagram of the LCD panel 20 and the peripheral driving circuits thereof according to an embodiment of the invention. As shown in the figure, an LCD panel 20 is formed by interlacing data electrodes (represented by D1, D2, D3, . . . , D2m) and gate electrodes (represented by G1, G2, G3, . . . , G2n), each pair of which controls a display unit. In addition, the data electrodes cross the gate electrodes. In a display frame, gate driver 200 provides turn-on signals to corresponding gate electrodes in predetermined scan directions (indicated by the arrows in FIG. 3), wherein the scan direction of the odd gate electrodes (G1, G3, G5, . . . , G2n-1) is in a first direction (top to bottom), and the scan direction of the even gate electrodes (G2, G4, G6, . . . , G2n) is in a second direction (bottom to top). As described, the time difference between providing the turn-on signals of gate electrode G1 and G2n due to shared data electrode, dictates the time for providing the turn-on signal to gate electrode G1 by gate driver 200 can be earlier or later than that to gate electrode G2n, and the range of the time difference can be about 1 to 20 μs, preferably about 5 to 10 μs. As shown in FIG. 3, in each frame, turn-on signals are provided to odd gate electrodes G1, G3, G5, . . . , G2n-1 from top to bottom, and to even gate electrodes G2, G4, G6, . . . , G2n from bottom to top. Another example of the scan direction is shown in FIG. 4. In even frames (the nth frames), turn-on signals are provided to odd gate electrodes G1, G3, G5, . . . , G2n-1 from top to bottom, and to even gate electrodes G2, G4, G6, . . . , G2n from bottom to top. In odd frames (the (n+1)th frames), turn-on signals are provided to odd gate electrodes G1, G3, G5, . . . , G2n-1 from bottom to top, and to even gate electrodes G2, G4, G6, . . . , G2n from top to bottom, opposite to these in even frames. The difference between the disclosed and the conventional methods is that the conventional methods comprise scanning the gate electrodes in an identical direction while the embodiment of the invention comprises scanning the odd gate electrodes and even gate electrodes in opposite directions. Thus, in the (n+1)th frame, the scan direction of the turn-on signal provided to odd gate electrodes of R, G, or B sub-frames can be identical or opposite to that in the nth frame, and the scan direction of the turn-on signal provided to even gate electrodes of R, G, or B sub-frames in the (n+1)th frame can be identical or opposite to that in the nth frame.

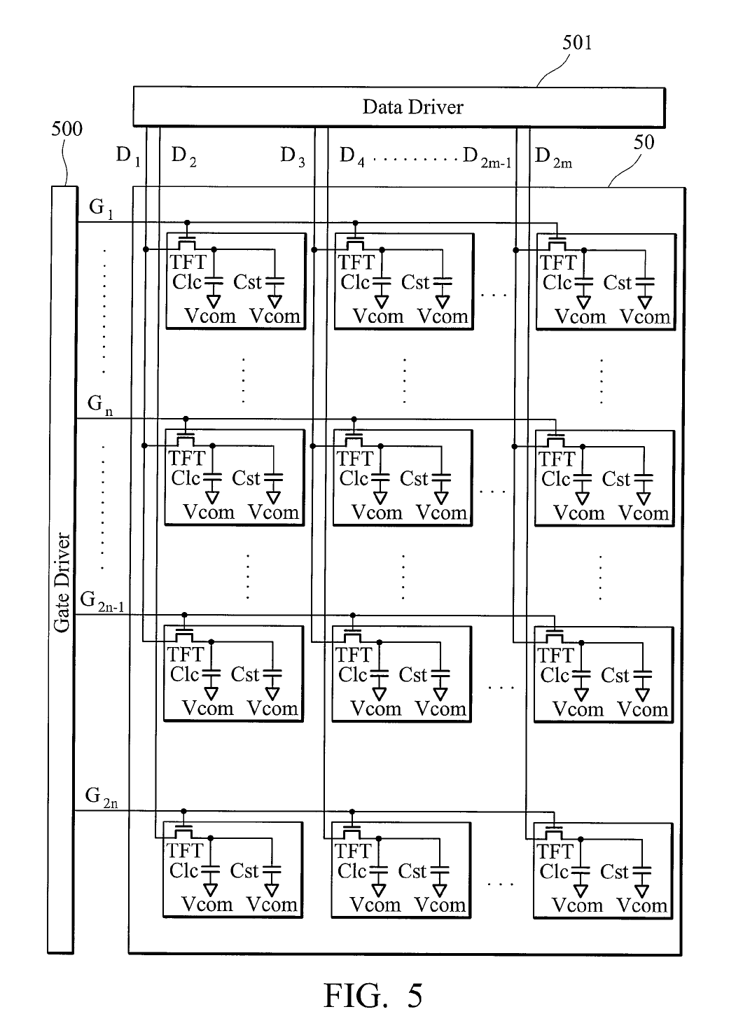

FIG. 5 is a schematic diagram of the LCD panel 50 and the peripheral driving circuits thereof according to another embodiment of the invention. The odd gate electrodes (G1, G3, G5, . . . , G2n-1) and the odd data electrodes (D1, D3, D5, . . . , D2m-1) are coupled to corresponding display units, while even gate electrodes (G2, G4, G6, . . . , G2n) and the even data electrodes (D2, D4, D6, . . . , D2m) are coupled to other corresponding display units. In this embodiment, the turn-on signal provided to odd gate electrodes (G1, G3, G5, . . . , G2n-1) is started at a first start time, and that provided to even gate electrodes (G2, G4, G6, . . . , G2n) is started at a second start time, a time difference between can be zero, or about 1 to 20 μs, preferably about 5 to 10 μs.

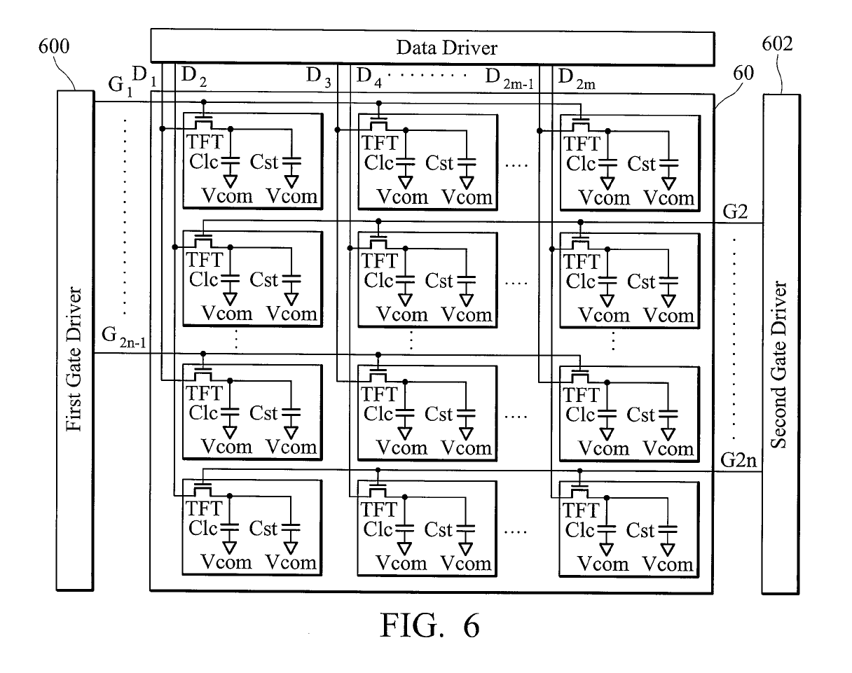

FIG. 6 is a schematic diagram of the LCD panel 60 and the peripheral driving circuits thereof according to another embodiment of the invention. First gate driver 600 provides the turn-on signals to odd gate electrodes (G1, G3, G5, . . . , G2n-1), and second gate driver 602 provides the turn-on signals to even gate electrodes (G2, G4, G6, . . . , G2n).

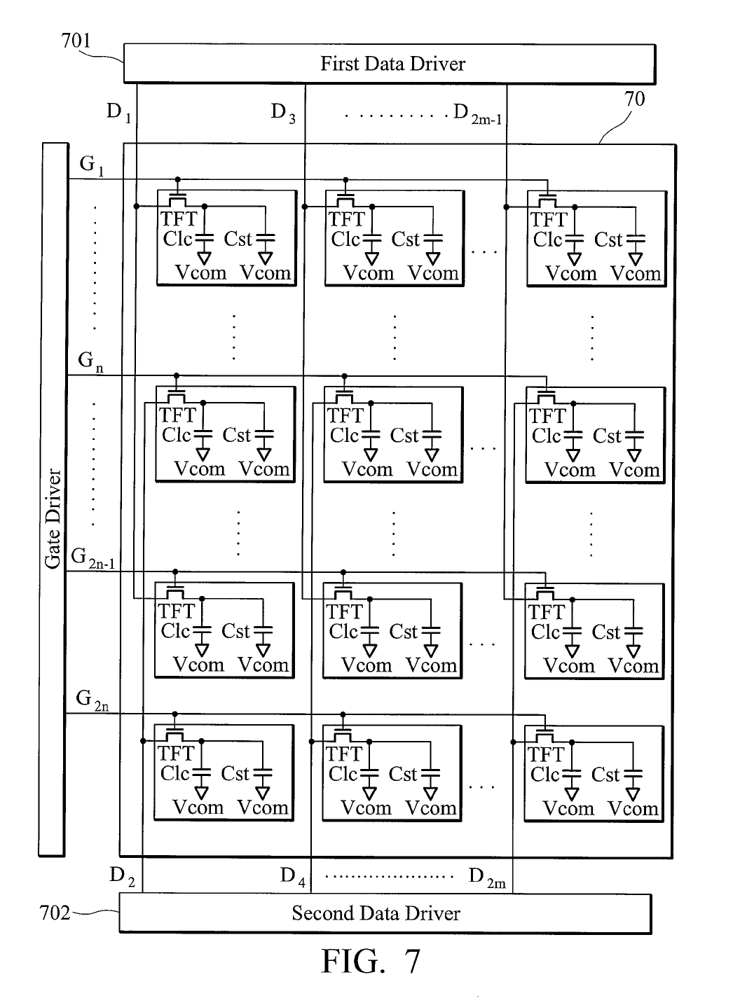

FIG. 7 is a schematic diagram of the LCD panel 70 and the peripheral driving circuits thereof according to another embodiment of the invention. First data driver 701 provides the data signals to odd data electrodes (D1, D3, D5, . . . , D2m-1), second data driver 702 provides the data signals to even data electrodes (D2, D4, D6, . . . , D2m), and odd data electrodes (D1, D3, D5, . . . , D2m-1) and even data electrodes (D2, D4, D6, . . . , D2m) are interlaced and substantially parallel to each other.

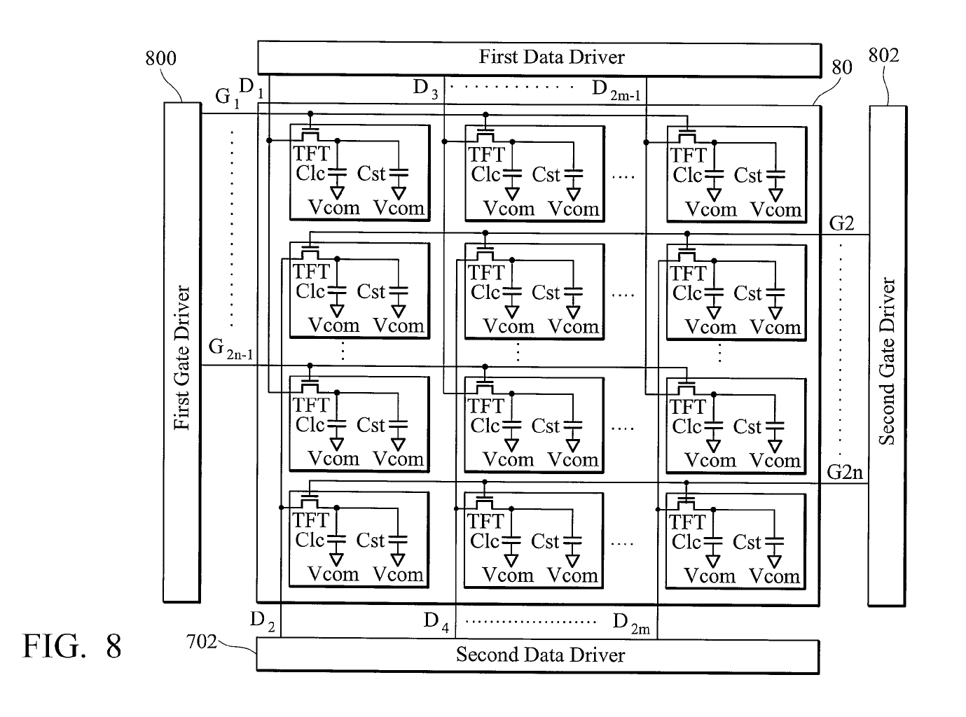

FIG. 8 is a schematic diagram of the LCD panel 80 and the peripheral driving circuits thereof according to another embodiment of the invention. First gate driver 800 provides the turn-on signals to odd gate electrodes (G1, G3, G5, . . . , G2n-1), and second gate driver 802 provides the turn-on signals to even gate electrodes (G2, G4, G6, . . . , G2n).

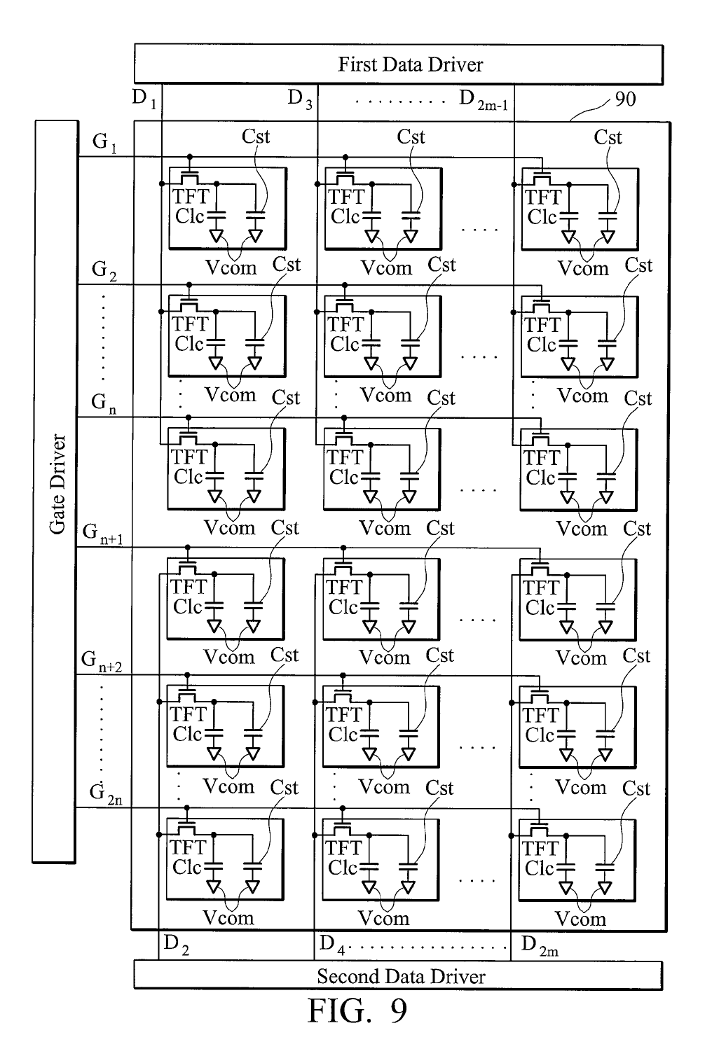

FIG. 9 is a schematic diagram of the LCD panel 90 and the peripheral driving circuits thereof according to another embodiment of the invention. The arrangement of odd gate electrodes (G1, G3, G5, . . . , G2n-1) and even gate electrodes (G2, G4, G6, . . . , G2n) are not interlaced. In this embodiment, odd gate electrodes (G1, G3, G5, . . . , G2n-1) are located on the upper portion of LCD panel 90, and even gate electrodes (G2, G4, G6, . . . , G2n) on the lower portion of LCD panel 90. Thus, odd data electrodes (D1, D3, D5, . . . , D2m-1) and even data electrodes (D2, D4, D6, . . . , D2m) are aligned but not interlaced.

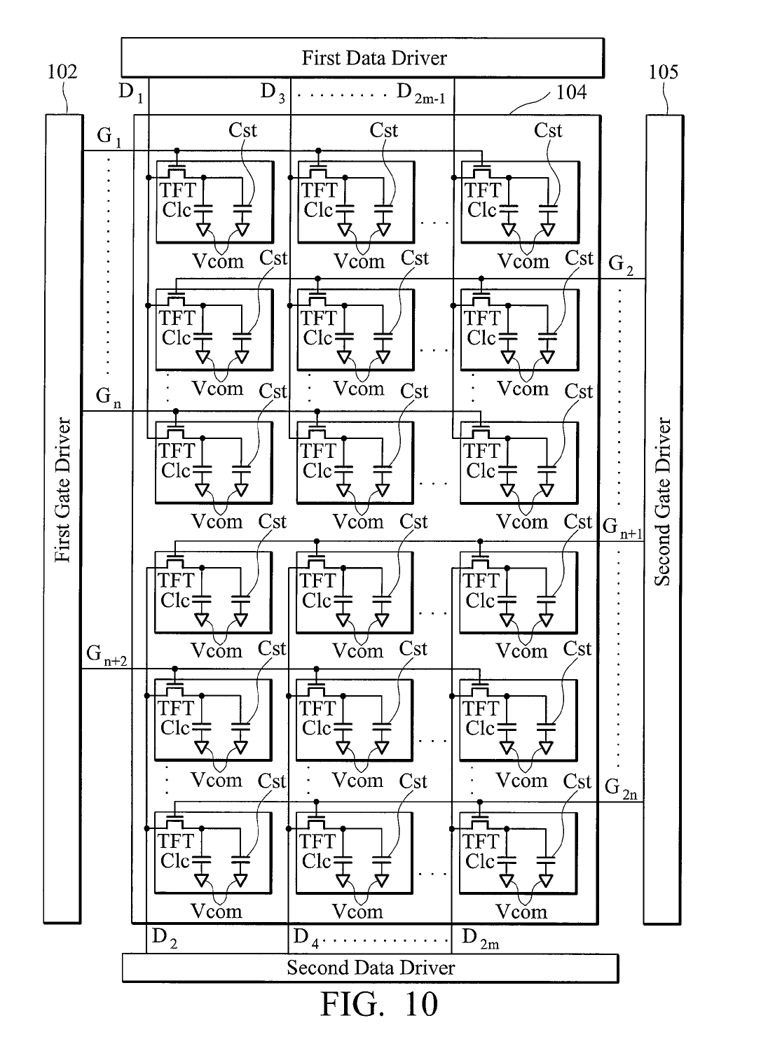

FIG. 10 is a schematic diagram of the LCD panel 104 and the peripheral driving circuits thereof according to another embodiment of the invention. First gate driver 102 provides the turn-on signals to odd gate electrodes (G1, G3, G5, . . . , G2n-1), and second gate driver 105 provides the turn-on signals to even gate electrodes (G2, G4, G6, . . . , G2n).

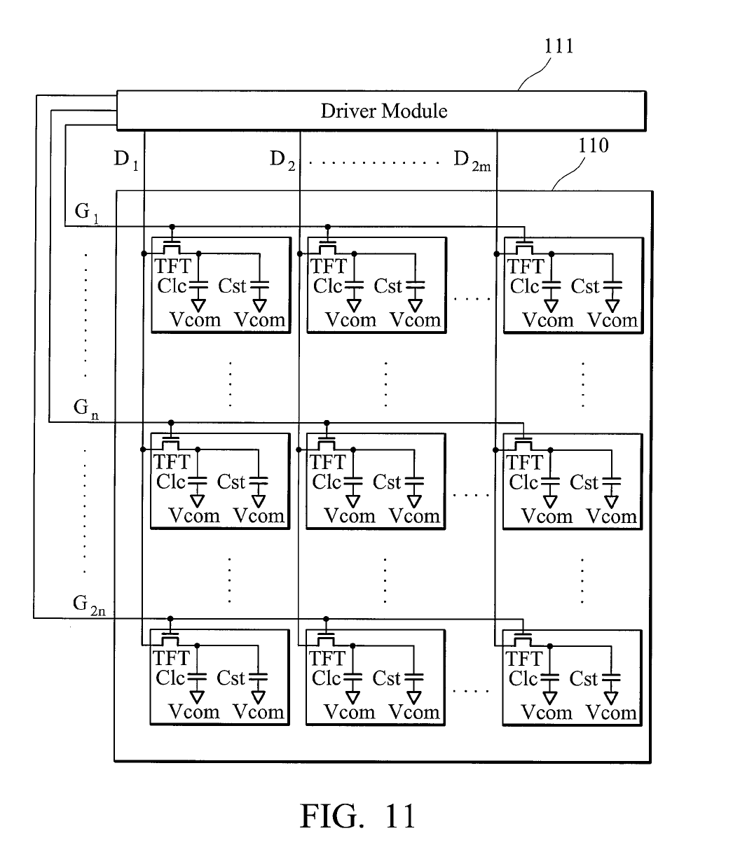

FIG. 11 is a schematic diagram of the LCD panel 110 and the peripheral driving circuits thereof according to another embodiment of the invention. Gate driver 200 and data driver 201 are integrated in driver module 111.

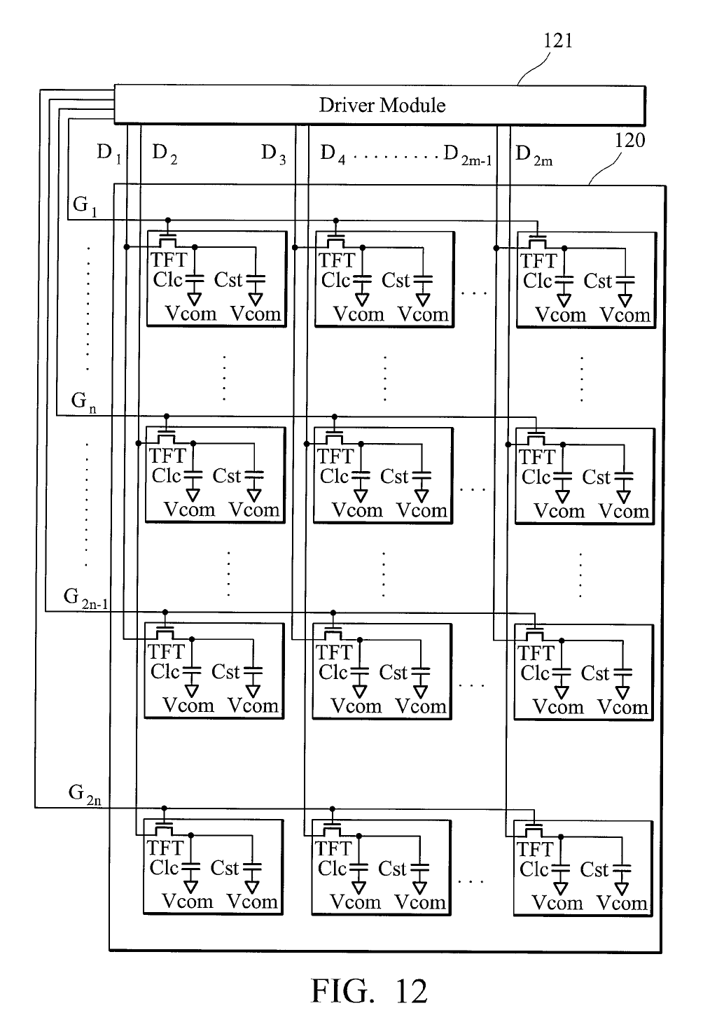

FIG. 12 is a schematic diagram of the LCD panel 120 and the peripheral driving circuits thereof according to another embodiment of the invention. Gate driver 500 and data driver 501 are integrated in driver module 121.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for driving a liquid crystal display panel comprising a plurality of first gate electrodes, second gate electrodes, data electrodes, and a plurality of display units respectively connecting to the data electrodes and one of the first gate electrodes and the second gate electrodes, the method comprising:
providing a turn-on signal to the first gate electrodes in sequence in a first direction and providing the turn-on signal to the second gate electrodes in sequence in a second direction opposite to the first direction during a frame; and
providing a data signal to the data electrode corresponding to one of the first gate electrodes and the second gate electrodes while providing the turn-on signal to the first gate electrodes and the second gate electrodes corresponding to the data electrode.

2. The method as claimed in claim 1, wherein the first gate electrodes and the second gate electrodes are substantially parallel to each other.

3. The method as claimed in claim 1, wherein the first gate electrodes and the second gate electrodes are interlaced.

4. The method as claimed in claim 1, wherein the turn-on signal provided to the first gate electrodes is started at a first start time.

5. The method as claimed in claim 4, wherein the turn-on signal provided to the second gate electrodes is started at the first start time.

6. The method as claimed in claim 5, wherein the data electrodes comprise a plurality of first data electrodes and second data electrodes, one of the first data electrodes is coupled to one of the display units coupled to one of the first gate electrodes, and one of the second data electrodes is coupled to another one of the display units coupled to one of the second gate electrodes.

7. The method as claimed in claim 6, wherein the first data electrodes and second data electrodes are interlaced and substantially parallel to each other

8. The method as claimed in claim 6, wherein the first data electrodes and second data electrodes are located on an upper portion and a lower portion of the liquid crystal display panel, respectively.

9. The method as claimed in claim 4, wherein the turn-on signal provided to the second gate electrodes is started at a second start time different from the first start time.

10. The method as claimed in claim 9, wherein a time difference between the first start time and the second start time is about 1 to 20 μs.

11. The method as claimed in claim 9, wherein a time difference between the first start time and the second start time is about 5 to 10 μs.

12. The method as claimed in claim 9, wherein the data electrodes comprise a plurality of first data electrodes and second data electrodes, one of the first data electrodes is coupled to one of the display units coupled to one of the first gate electrodes, and one of the second data electrodes is coupled to another one of the display units coupled to one of the second gate electrodes.

13. The method as claimed in claim 12, wherein the first data electrodes and second data electrodes are interlaced and substantially parallel to each other.

14. The method as claimed in claim 12, wherein the first data electrodes and second data electrodes are located on an upper portion and a lower portion of the liquid crystal display panel, respectively.

15. A method for driving a liquid crystal display panel comprising a plurality of first gate electrodes, second gate electrodes, data electrodes, and a plurality of display units respectively connecting to the data electrodes and one of the first gate electrodes and the second gate electrodes, the method comprising:
providing a turn-on signal to the first gate electrodes in sequence in a first direction and providing the turn-on signal to the second gate electrodes in sequence in a second direction opposite to the first direction during a frame;
providing the turn-on signal to the first gate electrodes in sequence in the second direction and providing the turn-on signal to the second gate electrodes in sequence in the first direction during another frame next to the frame; and
providing at least one data signal to one of the data electrodes corresponding to one of the first gate electrodes and the second gate electrodes while providing the turn-on signal to the first gate electrodes and the second gate electrodes corresponding to the one of the data electrodes.

16. The method as claimed in claim 15, wherein the first gate electrodes and the second gate electrodes are substantially parallel to each other.

17. The method as claimed in claim 15, wherein the first gate electrodes and the second gate electrodes are interlaced.

18. The method as claimed in claim 15, wherein the turn-on signal provided to the first gate electrodes is started at a first start time.

19. The method as claimed in claim 18, wherein the turn-on signal provided to the second gate electrodes is started at the first start time.

20. The method as claimed in claim 18, wherein the turn-on signal provided to the second gate electrodes is started at a second start time different from the first start time.

21. The method as claimed in claim 20, wherein a time difference between the first start time and the second start time is about 1 to 20 μs.

22. The method as claimed in claim 21, wherein a time difference between the first start time and the second start time is about 5 to 10 μs.

23. A liquid crystal display device, comprising:
a liquid crystal display panel comprising a plurality of first gate electrodes, first data electrodes, and a portion of a plurality of display units respectively connecting to the first data electrodes and the first gate electrodes; and
at least one driver module for providing a turn-on signal to the first gate electrodes in sequence in a first direction, for providing the turn-on signal to the second gate electrodes in sequence in a second direction opposite to the first direction, and for providing a data signal to the first data electrodes corresponding to the first gate electrodes while the turn-on signal is provided to the first gate electrodes, and to the second data electrodes corresponding to the second gate electrodes while the turn-on signal is provided to the second gate electrodes during a frame.

24. The method as claimed in claim 23, wherein the liquid crystal display panel further comprises a plurality of second gate electrodes and second data electrodes, and another portion of the plurality of display units connecting to the second gate electrodes and second data electrodes.

25. The method as claimed in claim 24, wherein the at least one driver module comprises:
at least one gate driver for providing the turn-on signal to the first gate electrodes in sequence in the first direction, and for providing the turn-on signal to the second gate electrodes in sequence in the second direction; and
at least one data driver for providing the data signal to the first data electrodes corresponding to the first gate electrodes while the turn-on signal is provided to the first gate electrodes, and to the second data electrodes corresponding to the second gate electrodes while the turn-on signal is provided to the second gate electrodes.

26. The method as claimed in claim 25, wherein the at least one gate driver comprises:
a first gate driver for providing the turn-on signal to the first gate electrodes in sequence in the first direction; and
a second gate driver for providing the turn-on signal to the second gate electrodes in sequence in the second direction.

27. The method as claimed in claim 25, wherein the least one data driver comprises:
a first data driver for providing the data signal to the first data electrodes corresponding to the first gate electrodes while the turn-on signal is provided to the first gate electrodes; and
a second data driver for providing the data signal to the second data electrodes corresponding to the second gate electrodes while the turn-on signal is provided to the second gate electrodes.

28. The method as claimed in claim 26, wherein the least one data driver comprises:
a first data driver for providing the data signal to the first data electrodes corresponding to the first gate electrodes while the turn-on signal is provided to the first gate electrodes; and
a second data driver for providing the data signal to the second data electrodes corresponding to the second gate electrodes while the turn-on signal is provided to the second gate electrodes.

29. A method for driving a liquid crystal display panel, comprising:
providing a turn-on signal to a plurality of first gate electrodes in sequence in a first direction and providing the turn-on signal to a plurality of second gate electrodes in sequence in a second direction, wherein the second direction is opposite to the first direction and the first gate electrodes and the second gate electrodes are interlaced; and
providing at least one data signal to a plurality of data electrodes corresponding to the first gate electrodes and the second gate electrodes.

30. A method for driving a liquid crystal display panel, comprising:
providing a turn-on signal to a plurality of first gate electrodes in sequence in a first direction and providing the turn-on signal to a plurality of second gate electrodes in sequence in a second direction during a frame, wherein the second direction is opposite to the first direction; and
providing at least one data signal to a plurality of data electrodes corresponding to the first gate electrodes and the second gate electrodes.
